(19) United States
(12) Patent Application Publication
(10) Pub. No.: US 2023/0032863 A1
(43) Pub. Date: Feb. 2, 2023

(54) METHOD FOR SECURELY AND PRIVATELY SHARING USER DATA ITEMS WITH THIRD PARTIES

(71) Applicant: GEROMICS LTD, Cambridge (GB)

(72) Inventors: Daniel Murray Bolser, Cambridge (GB); Carlos Massiah, Cambridge (GB)

(21) Appl. No.: 17/788,352

(22) PCT Filed: Dec. 23, 2020
(86) PCT No.: PCT/GB2020/053350

§ 371 Date: Jun. 23, 2022

(30) Foreign Application Priority Data
Dec. 24, 2019 (GB) 1919282.2

(51) Int. Cl. G06F 21/62; G06F 21/60

(52) U.S. Cl. CPC G06F 21/6245; G06F 21/604; G06F 2221/2115

(57) ABSTRACT

Broadly speaking, embodiments of the present techniques provide methods and systems to enable a user to securely and privately share their data with selected third parties in a way that ensures the user retains at least some control over their data at all times. Thus, the present techniques enable a user to benefit from the results of sharing their data (e.g. access to health related products or services kudos or a reward), without losing control of their data and without unauthorised use of their data. A user may add user data items into a storage and may specify for each user data item a permission setting that specifies whether or not the user data item may be shared, who it can be shared with or for what purpose it can be shared. A third party who is granted access to a user data item is able to access the user data item via a secure portal, but is not able to remove, download or copy the data item from the storage itself. Thus, unauthorised use or sharing of user data is prevented.

The present techniques generally relate to systems and methods for securely and privately sharing user data items with third parties, and in particular relate to techniques that enable a user to control who can access their data. The data items being shared may be genome data or other personal data.

A user may subscribe to or sign-up to use the services of a particular company, or may purchase a service from a company. For example, a user may sign-up to a platform which stores and analyses data collected from a smartwatch or sports watch worn by the user. In another example, a user may pay for a company to perform genomic analysis on their own DNA. In many cases, the platform owner, service provider or company (i.e. third party) owns the data and any analysis performed on the data. Typically, users or individuals do not have any control over the data that the third party has collected or obtained, and do not have any control over how the third party may use the data or share the data with other companies. Such services may offer users substantial benefit, however, loss of data sovereignty (privacy and control) is a major pitfall.

Background information can be found in: US2019/0163928 which discloses a system and method for managing personal data stored by an enterprise; US2011/0119732 which discloses a system and method for allowing a web-services user to control access to user-specific information stored with a web-services service; US2013/0091172 which discloses a journaling system that provides a repository for various types of user information or content and for controlling access to such information by third parties; US2010/0185871 which discloses a personal information system allowing users to securely collect, store, and allow access to personal information; US2016/0285884 which discloses a process of configurable sharing of user information and system which may include a user device that enables a user to specify privacy settings for sharing user information with user information consumers; and US2012/0317109 which discloses a method for a user to adjust their privacy settings on a social networking system. However, none of these documents disclose techniques that provide a user with full control of who has access to their data at all times, or techniques that enable a user to control who they share their data with and for what purpose.

The present applicant has identified the need for a system that allows users to securely and privately share their data and to control who can access their data.

In a first approach of the present techniques, there is provided a method for securely sharing user data items with third parties, the method comprising: receiving, from a user, a request to share a user data item, the request comprising: information identifying a user data item to be shared, information identifying a user profile for sharing the user data item, and information specifying a permission setting for the user data item to be shared; and storing, in storage, an association between the permission setting, the identified user profile and the user data item.

As mentioned above, the present techniques provide a user with the ability to securely share their data with third parties in a controlled manner. The user may have a number of user data items (including but not limited to health data, genomic data, lifestyle data, location data, personal data, and biometric data), and the user may wish to share the user data items with different third parties. For example, the user may wish to share their health data with a medical insurance company, but does not want to share this data with any other company. The user data items may be stored in a secure storage, and the user can access their user data items whenever they wish, and can add or delete user data items from the storage. Third parties may be able to submit queries to determine if data they need for research or analytics purposes is stored in the storage. However, the third parties cannot see or access any particular user data item unless the user associated with the user data item has expressly provided them with permission to do so. The present techniques enable a user to specify a permission setting for each user data item that is stored in the storage. The permission setting may specify that a particular user data item can be accessed by any third party (i.e. available to all), or cannot be accessed by any third party (i.e. available to none), or may specify access controls between these two extremes.

A distributed identity (also known as a decentralised identity) is a type of identity which is fully under the control of a user/person who is the subject of the identity, and is independent from any centralised registry, identity provider or certificate authority. A DID allows individuals to securely and privately store all elements of their digital identity in a way that allows them to control who can access these elements and how these elements are used.

As explained in more detail below, once a user has created a single unique identity that gives them access to the storage in which they can store their user data items, the user may be able to create multiple profiles or accounts that are associated with that single unique identity. The term “profile” is used interchangeably herein with the term “account”. (The link between the different profiles/accounts owned by and created by the same user may exist outside of the data access platform described herein). For example, the user may wish to create a different profile for each service provider or third party that they want to share some of their data with. For example, the user may create one profile for medical insurance providers, another profile for research organisations, another profile for healthcare professionals, and so on. The profiles may enable a user to apply general/global permission settings to their user data based on the type of third party. Each profile may be associated with a distributed identity (DID) document. The DID document corresponding to a profile may comprise information on how the system is to interact with the profile and a method for the user to prove they own the profile. As stated above, when a user requests to share a user data item, they may provide information identifying a user profile for sharing the user data item. The information identifying a user profile for sharing the user data item may be one of: a distributed identity (DID) document, or a pointer to a distributed identity (DID) document. Thus, when the user makes a request to share a user data item, the user provides information that authenticates them and verifies that they are allowed to share the user data item.

As noted above, a user may be able to create multiple profiles, and each user profile may be used to share at least one user data item with a third party, as per specific permission settings set by the user. Each profile may be associated with a DID document, but the DID may only be used to identify the user profile. Accordingly, the DID itself does not contain any permission settings or any user data items.

The storage stores user data items. However, the request to share a user data item may be received before that user data item has been stored in the storage. Thus, the method may comprise determining whether the identified user data item (specified in the request) is available in the storage and available to the user for sharing.

If the user data item is identified in storage and is available to the user for sharing, the method may comprise associating the identified user data item with the stored permission setting. This may be the case if the user has already obtained the data item and saved it in the storage. The user may have obtained (e.g. by purchasing) the data item from a third party, and saved the data into the storage. In some cases, the user may have purchased the data item from a third party, and the third party may have saved the data into storage on behalf of the user. For example, a third party company may provide data as a service (e.g. genomic analysis), and may have a relationship with the storage provider that allows them to put the data they generate for users/customers into the storage, so that the user can access their own data directly from the storage.

Alternatively, the user data item may be available in storage but may not be available to the user for sharing. This may be the case if, for example, a third party company has stored data they generated for users/customers in the storage, but the user has not yet taken the necessary steps to obtain or claim that data. Thus, the method may comprise: providing the user with an option to obtain the identified user data item; and associating, when the user obtains the identified user data item, the identified user data item with the stored permission setting.

Alternatively, if the user data item is not available in the storage (e.g. because the request to share has been made before the data item has been added to the storage), the method may comprise requesting the identified user data item from the user.

The user may be able to specify any permission setting for each user data item associated with/belonging to the user in the storage. For example, the information (in the request) specifying a permission setting for the user data item may comprise any one or more of: information restricting access to the user data item to a specific third party, information specifying the user data item can be used by a predefined set of third parties, information specifying that the user data item can be used for private research, information specifying that the user data item can be used for public research, and information specifying that the user data item can be used for private and public research. It will be understood that this is a non-exhaustive and non-limiting list of example permission settings, and that other more specific permission settings may be used.

The user data item to be shared may comprise any one of: genome data, health data, lifestyle data, location data, personal data, and biometric data. It will be understood that this is a non-exhaustive and non-limiting list of example types of user data.

As mentioned above, third parties may be able to submit queries to determine if data they need for research or analytics purposes is stored in the storage. However, the third parties cannot see or access any particular user data item unless the user associated with the user data item has expressly provided them with permission to do so. In response to a query received from a third party, it may desirable to provide the third party with information indicating whether any data matching their query exists in the storage. However, even if data matching the query exists in the storage, the data may not be available to the third party because of the permission settings set by each user. Thus, it may be advantageous to separate the data stored in the storage into two groups: searchable data and non-searchable data. The searchable data includes the user data items that users have explicitly stated may be searched by a third party. The non-searchable data includes the user data items that users have stated may not be searched by a third party. Thus, when a third party queries the system, they are only able to do so with respect to the user data items that are marked/categorised as being searchable. Thus, the method may comprise: adding the user data item to be shared to a database of searchable data, based on the permission setting.

As the system enables a user to have at least some control (if not full or complete control) over their data, the method may further comprise: receiving, from the user, a request to revoke access by third parties to a previously shared user data item. In response to this request, the method may comprise removing the previously shared user data item from a database of searchable data. Alternatively, the method may comprise deleting, responsive to the request, the previously shared user data item from the storage.

Thus far, methods for how a user may share user data items have been described. However, the present techniques also provide methods for enabling a third part to obtain access to user data items that a user has permitted to be shared.

In a second approach of the present techniques, there is provided a method for securely sharing user data items with third parties, the method comprising: receiving, from a third party, a search query relating to a particular type of user data and a reason for wanting the user data; identifying, in storage, a plurality of user data items matching the search query; determining, using permission settings associated with each user data item and the received reason, a first subset of user data items that can be shared with the third party; and providing, to the third party, a response to the search query comprising a size of the first subset of user data items that match the received search query.

As mentioned above, a user may specify that a specific data item can only be accessed for a particular use/purpose (e.g. private and/or public research) or by a particular type of organisation (e.g. Universities, research organisations, non-profit organisations, commercial companies, etc.) Thus, the third party may have to specify a reason why they want to access the user data items, so that only those user data items that are permitted to be shared for that reason are used to provide a response to the query.

A first response to the query may simply be a number equal to the number of user data items in the first subset (i.e. which match the received search query and have permissions settings corresponding to the received reason). This may help the third party to determine if they want to proceed further and request full access to the user data items. For example, if only a small number of user data items are identified, then the third party may not wish to obtain full access to the user data items, as the number may be too small to analyse and reach meaningful conclusions.

The method may comprise: receiving, from the third party, a request to access the first subset of user data items; and providing the third party with an access token to enable the third party to access the first subset of user data items through a secure portal. In some cases, the access token may enable the third party to view the first subset of user data items via the secure portal, but not to be able to download or copy the user data items. In this way, the user data items that are shared with a third party do not leave the storage and copies are not provided to the third party. Thus, the user retains at least some control (if not full/complete control) of their user data at all times.

It may be desirable to provide a user associated with each user data item accessed by a third party with feedback so that they know that a third party has accessed their data. The method may comprise: identifying a user associated with each user data item of the first subset of user data items; and transmitting, to each identified user, a message indicating that a third party is accessing their user data item for the received reason.

In some cases, to encourage users to share more of their data, the method may comprise providing a reward, to each identified user associated with the first subset of user data items.

The method may further comprise: determining a second subset of user data items that cannot be shared with the third party; identifying a user associated with each user data item of the second subset; and transmitting, to each identified user, a message indicating that a third party wants access to the user data item of the second subset associated with the user. Thus, the method enables users who have not already specified that the third party requesting the data can access their data with the opportunity to change the permission settings. This may be useful if, for example, a user has not provided any specific permission settings or has simply used default permission settings for their user data. By default, each user data item may be non-searchable and not shareable with any third party, to ensure the data remains private until the user specifies otherwise. However, if a user has not had time to change the permission settings, this method may prompt the user to do so in response to a third party request for particular data.

The size of the second subset of user data items, or any other information about the second subset may not be shared with the third party. However, if a user associated with a user data item in the second subset changes their permission settings to allow the third party to access the data item, the third party may be sent a message stating that another user data item has become available, and provide them with the option to obtain full access to the newly available user data item.

The method may further comprise: receiving, from the third party, a purchase request in relation to the first and/or second subset of user data items in the response.

The response to the search query may comprise a cost to access the subset of user data items. In this case, the method may further comprise: receiving, from the third party, a payment corresponding to the cost to access the subset of user data items; and providing the third party with an access token to enable the third party to access the first subset of user data items through a secure portal.

In a third approach of the present techniques, there is provided a system for securely sharing user data items with third parties, the system comprising: a data access platform comprising: storage for storing a plurality of user data items and at least one permission setting associated with each user data item; a user interface for receiving, from a user, a request to share a user data item; a third party user interface for receiving, from a third party, a search query relating to a particular type of user data and a reason for wanting the user data; and a processor for carrying out any of the methods described herein.

The system may further comprise: an identity authentication platform comprising: storage storing a plurality of distributed identity documents (DIDs), wherein at least one DID is associated with each user of the system.

In a related approach of the present techniques, there is provided a non-transitory data carrier carrying processor control code to implement any of the methods, processes and techniques described herein.

As will be appreciated by one skilled in the art, the present techniques may be embodied as a system, method or computer program product. Accordingly, present techniques may take the form of an entirely hardware embodiment, an entirely software embodiment, or an embodiment combining software and hardware aspects.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object oriented programming languages and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

Embodiments of the present techniques also provide a non-transitory data carrier carrying code which, when implemented on a processor, causes the processor to carry out any of the methods described herein.

The techniques further provide processor control code to implement the above-described methods, for example on a general purpose computer system or on a digital signal processor (DSP). The techniques also provide a carrier carrying processor control code to, when running, implement any of the above methods, in particular on a non-transitory data carrier. The code may be provided on a carrier such as a disk, a microprocessor, CD- or DVD-ROM, programmed memory such as non-volatile memory (e.g. Flash) or read-only memory (firmware), or on a data carrier such as an optical or electrical signal carrier. Code (and/or data) to implement embodiments of the techniques described herein may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog (RTM) or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

It will also be clear to one of skill in the art that all or part of a logical method according to embodiments of the present techniques may suitably be embodied in a logic apparatus comprising logic elements to perform the steps of the above-described methods, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In an embodiment, the present techniques may be implemented using multiple processors or control circuits. The present techniques may be adapted to run on, or integrated into, the operating system of an apparatus.

In an embodiment, the present techniques may be realised in the form of a data carrier having functional data thereon, said functional data comprising functional computer data structures to, when loaded into a computer system or network and operated upon thereby, enable said computer system to perform all the steps of the above-described method.

Implementations of the present techniques will now be described, by way of example only, with reference to the accompanying drawings, in which:

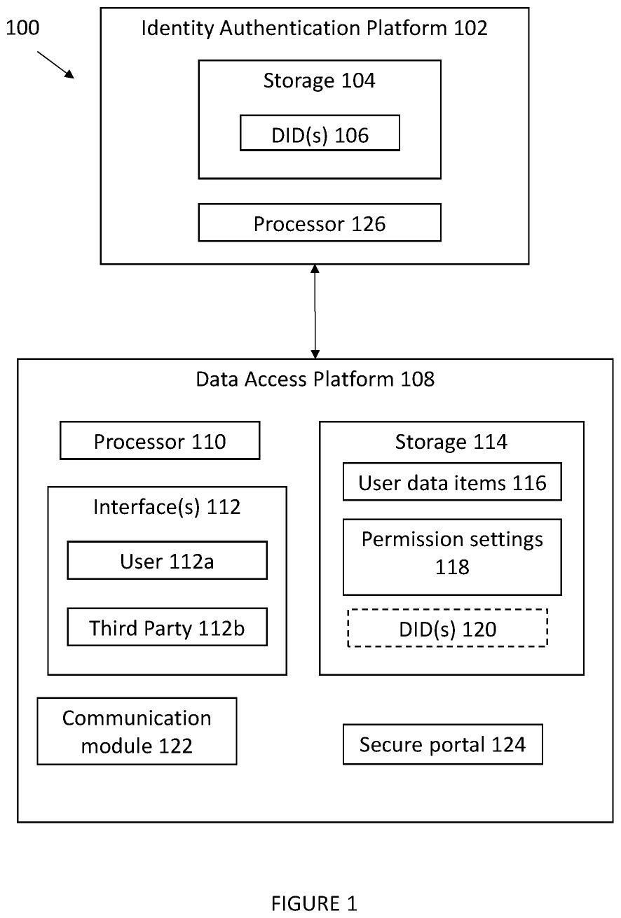

FIG. 1 shows a block diagram of a system for securely sharing user data items;

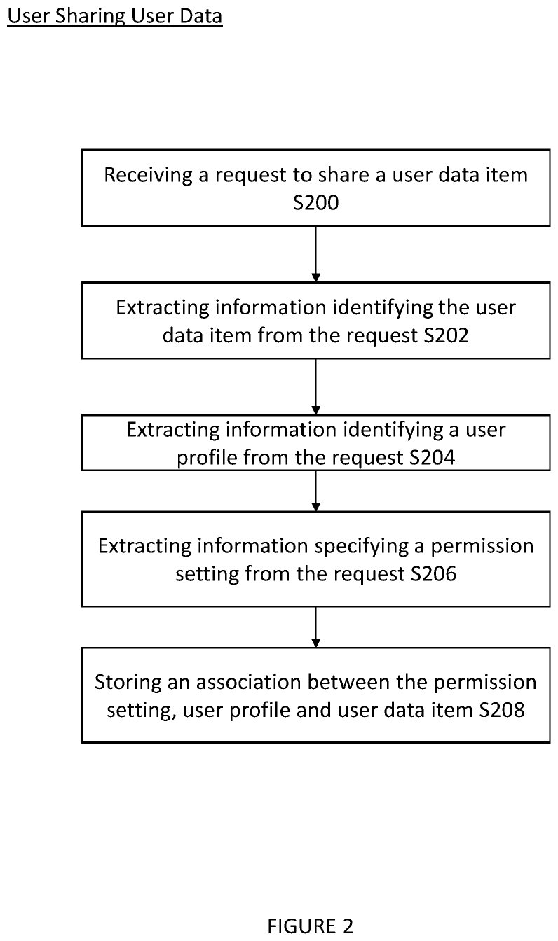

FIG. 2 shows a flowchart of example steps to enable a user to securely share their user data;

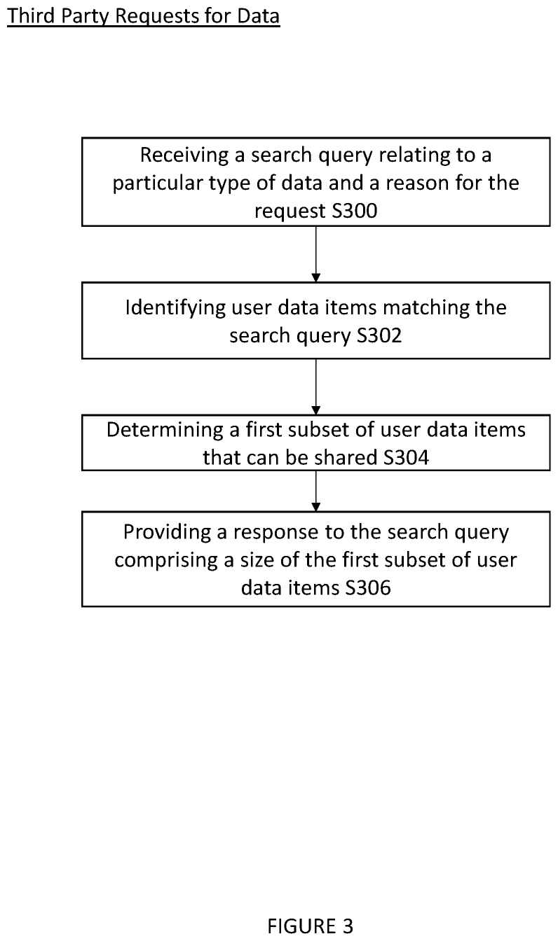

FIG. 3 shows a flowchart of example steps to enable a third party to access user data items; and

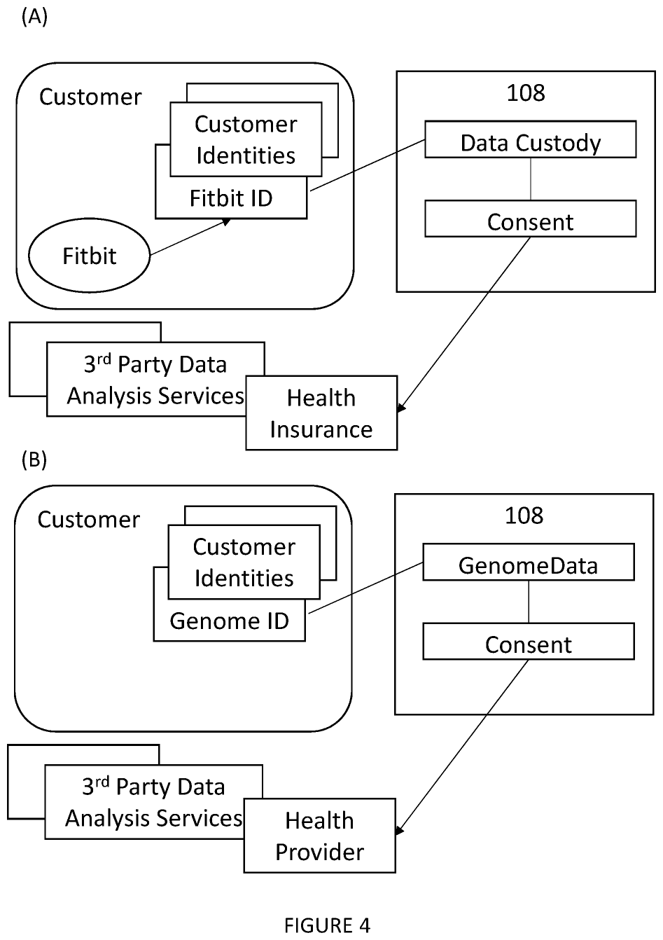

FIG. 4A and FIG. 4B show examples of how a user can control access to their user data items by different third parties using different profiles.

Broadly speaking, embodiments of the present techniques provide methods and systems to enable a user to securely share their data with selected third parties in a way that ensures the user retains at least some control over their data at all times. Thus, the present techniques enable a user to benefit from the results of sharing their data (e.g. kudos or a reward), without losing control of their data and without unauthorised use of their data. A user may add user data items into a storage and may specify for each user data item a permission setting that specifies whether or not the user data item may be shared, who it can be shared with or for what purpose it can be shared. A third party who is granted access to a user data item is able to access the user data item via a secure portal, but is not able to remove, download or copy the data item from the storage itself. Thus, unauthorised use or sharing of user data is prevented.

FIG. 1 shows a block diagram of a system 100 for securely sharing user data items with third parties. The system may comprise a data access platform 108. The data access platform 108 enables users to store user data items into a secure storage, and enables third parties to submit queries requesting access to particular user data items. The data access platform 108 may be accessed by users and third parties in any suitable way, e.g. via a software application (app′) or via a web browser.

The data access platform 108 may comprise storage 114 for storing a plurality of user data items 116 and at least one permission setting 118 associated with each user data item. In some cases, storage 114 may comprise a DID document associated with a user profile/account, or may comprise a pointer to each DID document stored elsewhere in system 100. The storage 114 may comprise a volatile memory, such as random access memory (RAM) for use as temporary memory, and/or non-volatile memory such as Flash, read only memory (ROM), or electrically erasable programmable ROM (EEPROM), for storing data, programs, instructions, etc. The storage 114 may comprise one or more databases.

The storage 114 may store user data items in a secure, encrypted format. In some cases, user data items may be custodied with multiple partners. That is, partners may store user data items in an encrypted form, but a single partner does not hold a complete set of data or a complete user data item, such that if one data store is breached, data remains secure. Thus, user data items may be split, encrypted and stored in multiple data stores managed by data custodians.

The data access platform 108 may comprise a plurality of interfaces 112 that enable the data access platform to receive inputs (e.g. requests from a user or third party) and to generate outputs (e.g. responses to the requests, or feedback to the user on how their data is being used). One of the plurality of interfaces 112 may be a user interface 112a for receiving, from a user, a request to share a user data item. The user interface 112a may be used to send information back to the user, e.g. to show them how their user is being used or who has accessed their data, to prompt the user to share their user data, and to provide the user with a reward when their user data has been shared with/accessed by a third party. Another of the plurality of interfaces 112 may be a third party user interface 112b for receiving, from a third party, a search query relating to a particular type of user data and a reason for wanting the user data. The third party user interface 112b may be used to send information back to the third party, e.g. to provide them with a response to their query, to provide them with the option to obtain access to user data items, and to provide them with access to the user data items.

The data access platform 108 may comprise at least one processor 110 or processing circuitry for carrying out any of the methods described herein. The processor 110 controls various processing operations performed by the data access platform 108, such as communicating with other components of the platform 108, communicating with other components within system 100, and processing requests received from users and third parties. The processor may comprise one or more of: a server, a microprocessor, a microcontroller, and an integrated circuit.

The data access platform 108 may comprise a communication module 122 to enable the platform 108 to communicate with other components of the system 100, or to communicate with companies in order to request and/or receive user data from the companies for storage in storage 114.

The data access platform 108 may comprise a secure portal 124, to enable a third party to access a subset of the user data items 116 stored in storage 114.

The system 100 may further comprise an identity authentication platform 102 comprising: storage 104 storing a plurality of distributed identity documents (DIDs) 106, wherein at least one DID 106 is associated with each user of the system 100.

The identity authentication platform 102 may further comprise at least one processor or processing circuitry 126. The processor 126 controls various processing operations performed by the identity authentication platform 102, such as communicating with other components of the platform 102, communicating with other components within system 100, and processing requests received from users to create user profiles, create DIDs, move or delete DIDs, etc. The processor 126 may comprise one or more of: a server, a microprocessor, a microcontroller, and an integrated circuit.

The data access platform 108 provides secure data storage to users, with full rights to and control over their data. The data access platform 108 may allow them to profit from their data assets. Each user may use a blockchain-based DID to interact with the data access platform 108, but this is not required and other types of DIDs may be used. (The DID may only be used to identify a user profile to be used for sharing user data items with a third party, but the DID itself does not contain permission settings.) Organisations wishing to use user data for research purposes may be able to use the data access platform 108 to find users and user data items (depending on the permission settings of the user data items) for their research. Analysis service providers may be able to market their products and services to users of the platform 108. For example, if a user has stored genome information or health information as user data items in storage 114, analysis service providers may be able to offer the user the chance to have their data analysed.

Users may benefit from the system 100 in a number of ways. For example, the system may empower users to unleash the potential of their genomic, clinical, medical, and/or lifestyle data. The system may enable users to obtain personalised interpretation or analysis of their data from data service providers. The system may enable users to monetise their data (e.g. private genomic data) to healthcare companies, while retaining ownership of the data. In one example, users who have their full genome sequence data may be able to open an account to access system 100 and store their data securely within system 100. Users of the platform 108 may be able to buy services that perform analysis on their data, such as cancer screening or ancestry discovery, while retaining full ownership of their data. Users have the option to consent to their data being used in research by other companies, and of earning rewards (such as kudos, monetary or non-monetary rewards) when their data is used.

Third parties, such as research organisations, may benefit from the system 100 in a number of ways. For example, the system may enable researchers to connect with specific users who—based on their user data—may be identified as being suitable to participate in a clinical trial. The system may remove the barrier of separate siloed genome or health data, as it offers the potential for researchers to gain access to many items of data.

Analysis service providers (e.g. genome analysis or lifestyle analysis companies) may benefit from the system 100 in a number of ways. For example, such companies may be able to provide tailored services to a user based on the user's genomic or clinical data. The system may enable streamlining of business processes, and remove any risks associated with data custody, as the user data remains in the system 100. The companies gain access to a vast array of users who may already have access to their full genome, and they can therefore provide the users with specific analysis services.

FIG. 2 shows a flowchart of example steps to enable a user to securely share their user data with third parties. The method may comprise receiving, from a user, a request to share a user data item (step S200). The request may be received via the user interface 112a of the data access platform 108. The received request may comprise: information identifying a user data item to be shared, information identifying a user profile for sharing the user data item, and information specifying a permission setting for the user data item to be shared. At steps S202 to S206, the method may comprise extracting these individual pieces of information from the request. The method may comprise storing, in storage 114, an association between the permission setting, the identified user profile and the user data item.

An illustrative example of how the process shown in FIG. 2 may be applied in practice is now provided. In this example, a user of the data access platform 108 may visit a website which offers a nutrigenomics service. The nutrigenomics service may provide individuals with tailored information on nutrition and diet that is based on the individual's genome data. For instance, the nutrigenomics service may be able to tell an individual if their genome makes them suitable for the ketogenic diet (also known as the ‘keto diet’), because some individuals carry a gene which means that the keto diet will not have the desired effects on the individuals. In order for the user to determine if the keto diet suits them, the user needs to provide the nutrigenomics service provider with access to the user's genome data.

Thus, the user may use the data access platform 108 to grant temporary access to the third party (i.e. the nutrigenomics service provider) to a limited portion of the user's data. This portion of the user's data may be the user's genome or even only a part of the user's genome. In other words, the user may send a request to the data access platform 108 to share a user data item. The data access platform 108 may extract from the request the genome data that the user needs to provide to the third party (step S202), and the user-specified permission settings (step S206). The user-specified permission settings may state exactly who is allowed to access the data (i.e. the nutrigenomics service provider), what data they are allowed to access, what purpose they are allowed to access the data for, and how long they are permitted to access the data for. The user request may also contain information identifying a user profile (step S204).

Once this request has been processed by the data access platform and the association between the permission setting, user profile and user data item has been stored (step S208), the user can provide the nutrigenomics service provider with information on where to locate their genome data (i.e. may provide the details of the data access platform 108). The nutrigenomics service provider may then be able to access this specific data via the third party interface 112b on the data access platform 108, and perform the requested diet analysis. Once the user has obtained the answer about whether the keto diet is suitable for them from the nutrigenomics service provider, the user can reasonably expect that (a) the service provider no longer has access to their data, and (b) the service provider has no other information about the user or any way to identify the user. Thus, advantageously, the user is able to use a service without the service provider knowing anything about the user (or requiring the user to register with the service provider or create an account). This ensures that the user is able to access services provided by third parties while retaining full control over their personal data.

Thus, the present techniques enable a user to grant temporary access to a specific third party for a specific purpose, which not only means that the user has full control over their data, but also means that third parties do not have any data that they do not need and do not have access to any data after the temporary access expires or is terminated.

A further advantage is that a user may access/use the same service provided by a third party multiple times, or may access different services provided by a particular third party, without the third party knowing that the user is a repeat customer of their services. This is because every time the user wants to access a service provided by a third party, they grant access to that third party to their data via the data access platform 108, but no link between the user and the third party is created, and the third party may never receive any other identifying information that enables them to know if a user is a new or repeat user of their services.

As mentioned above, the present techniques provide a user with the ability to securely share their data with third parties in a controlled manner. The user may have a number of user data items (such as health data, genomic data, and biometric data), and the user may wish to share the user data items with different third parties. For example, the user may wish to share their health data with a medical insurance company, but does not want to share this data with any other company. The system 100 enables users to share their data using a range of consent options or permission settings. The present techniques enable a user to specify a permission setting for each user data item that is stored in the storage 114. For example, some users may not be happy for their data to be shared, while some users may be happy to share their data with any University research organisation. Thus, the permission settings enable a user to have granular control over their data. The permission setting may specify that a particular user data item can be accessed by any third party (i.e. available to all), or cannot be accessed by any third party (i.e. available to none), or may specify access controls between these two extremes.

A distributed identity (also known as a decentralised identity) gives users the ability to control their login information used to access platform 108. An advantage of using DIDs is that businesses/companies do not need to store personal data to identify users or enable a user to recover their account when they have forgotten their login details (e.g. by storing phone numbers, the user's mother's maiden name, etc.) Furthermore, DIDs enable users to create multiple accounts or profiles associated with a single unique identity. This provides a user with an additional degree of control over their personal and private data.

As explained in more detail below, once a user has created a single unique identity that gives them access to the storage in which they can store their user data items, the user may be able to create multiple profiles or accounts that are associated with that single unique identity. For example, the user may wish to create a different profile for each service provider or third party that they want to share some of their data with. For example, the user may create one profile for medical insurance providers, another profile for research organisations, another profile for healthcare professionals, and so on. The profiles may enable a user to apply general/global permission settings to their user data based on the type of third party. Each profile may be associated with a distributed identity (DID) document. The DID document corresponding to a profile may comprise information on how the system is to interact with the profile and a method for the user to prove they own the profile. As stated above, when a user requests to share a user data item, they may provide information identifying a user profile for sharing the user data item. The information identifying a user profile for sharing the user data item may be one of: a distributed identity, distributed identity (DID) document, or a pointer to a distributed identity (DID) document. Thus, when the user makes a request to share a user data item, the user provides information that authenticates them and verifies that they are allowed to share the user data item.

The storage 114 stores user data items 116. However, the request to share a user data item 116 may be received before that user data item has been stored in the storage. Thus, the method may comprise determining whether the identified user data item (specified in the request) is available in the storage and available to the user for sharing.

If the user data item is identified in storage 114 and is available to the user for sharing, the method may comprise associating the identified user data item with the stored permission setting. This may be the case if the user has already obtained the data item and saved it in the storage 114. The user may have obtained (e.g. by purchasing) the data item from a third party, and saved the data into the storage 114. In some cases, the user may have purchased the data item from a third party, and the third party may have saved the data into storage 114 on behalf of the user. For example, a third party company may provide data as a service (e.g. genomic analysis), and may have a relationship with the storage provider that allows them to put the data they generate for users/customers into the storage, so that the user can access their own data directly from the storage 114.

Alternatively, the user data item may be available in storage 114 but may not be available to the user for sharing. This may be the case if, for example, a third party company has stored data they generated for users/customers in the storage 114, but the user has not yet taken the necessary steps to obtain or claim that data. Thus, the method may comprise: providing the user with an option to obtain the identified user data item; and associating, when the user obtains the identified user data item, the identified user data item with the stored permission setting.

Alternatively, if the user data item is not available in the storage 114 (e.g. because the request to share has been made before the data item has been added to the storage), the method may comprise requesting the identified user data item from the user.

The user may be able to specify any permission setting for each user data item associated with/belonging to the user in the storage. For example, the information (in the request) specifying a permission setting for the user data item may comprise any one or more of: information restricting access to the user data item to a specific third party, information specifying the user data item can be used by a predefined set of third parties, information specifying that the user data item can be used for private research, information specifying that the user data item can be used for public research, and information specifying that the user data item can be used for private and public research. Broadly speaking, the permission setting may relate to access parties (e.g. one or more third parties who are permitted to access a user data item), to access duration (e.g. single access/one-time access, number of times the same user data item may be accessed, a period of time during which the user data item may be accessed, or a duration of time for which the user data item may be accessed), and/or access purpose (e.g. private research, public research, or a specific purpose). It will be understood that this is a non-exhaustive and non-limiting list of example permission settings, and that other more specific permission settings may be used.

The user data item to be shared may comprise any one of: genome data, health data, lifestyle data, location data, personal data, and biometric data. It will be understood that this is a non-exhaustive and non-limiting list of example types of user data.

As mentioned above, third parties may be able to submit queries, via the third party interface 112b, to determine if data they need for research or analytics purposes is stored in the storage. However, the third parties cannot see or access any particular user data item unless the user associated with the user data item has expressly provided them with permission to do so. In response to a query received from a third party, it may desirable to provide the third party with information indicating whether any data matching their query exists in the storage 114. However, even if data matching the query exists in the storage 114, the data may not be available to the third party because of the permission settings set by each user. Thus, it may be advantageous to separate the data stored in the storage into two groups: searchable data and non-searchable data. The searchable data includes the user data items that users have explicitly stated may be searched by a third party. The non-searchable data includes the user data items that users have stated may not be searched by a third party. Thus, when a third party queries the system, they are only able to do so with respect to the user data items that are marked/categorised as being searchable. Thus, the method may comprise: adding the user data item to be shared to a database of searchable data, based on the permission setting.

As the system enables a user to have at least some control (if not full control) over their data, the method may further comprise: receiving, from the user, a request to revoke access by third parties to a previously shared user data item. In response to this request, the method may comprise removing the previously shared user data item from a database of searchable data. Alternatively, the method may comprise deleting, responsive to the request, the previously shared user data item from the storage.

The present techniques may also preserve user privacy by preventing the system 100, and in particular the data access platform 108, from knowing that a particular user has used a particular service or set of services provided by third parties.

FIG. 4A and FIG. 4B show examples of how a user can control access to their user data items by different third parties using different profiles. In FIG. 4A, a user may store data collected by a smartwatch, sports watch or fitness tracking device (such as a Fitbit), in the platform 108. The user may have a number of user profiles and associated DIDs. Here, the user has a user profile and DID specifically for their Fitbit data. When a third party such as an insurance company wants access to the user's fitness or health data (as collected by the fitness tracking device), the request may be made to the platform 108. The user may request to share user data items corresponding to their fitness/health, or corresponding to their Fitbit user profile, and may specify a permission setting that allows the insurance company to access these specific user data items. Once the consent has been provided, the third party may be able to view/access the user data items via a secure portal.

In FIG. 4B, the same user is shown as have a user profile and DID for their genome data. A third party, such as a healthcare provider, may want access to the user's genome data. For example, researchers may want to survey users who have a specific genotype, but these users may only be identified by first accessing and analysing users' genome data. Again, the user may specify a permission setting using their genome user profile to enable the third party to access the user data items that are associated with the genome user profile. Once the consent has been provided, the third party may be able to view/access the genome data via a secure portal.

Thus far, methods for how a user may share user data items have been described. However, the present techniques also provide methods for enabling a third party to obtain access to user data items that a user has permitted to be shared.

There may be two ways to use the system 100 to provide business and researchers with access to datasets. One way comprises providing the third parties with access to platform 108 so that they can query whether any data exists that matches the criteria they need for their research. This is explained below with reference to FIG. 3. Another approach would be to approach companies who are looking for data with relevant datasets (taking into account the users' permission settings), and offer the datasets to the companies as a package. In any case, the user data items in the datasets are anonymised.

Turning to FIG. 3, this shows a flowchart of example steps to enable a third party to access user data items.

Third parties may be able to buy access to user data items via the data access platform 108, e.g. via a secure web portal 124, and to view the data through e.g. a REST API.

Third parties may be able to submit surveys, buy data and manage keys through the secure portal 124. If a third party wishes to purchase user data items, the third party is provided with an access token that enables them to view the user data items via the REST API.

The method may comprise receiving, from a third party (via the third party interface 112b), a search query relating to a particular type of user data and a reason for wanting the user data (step S300). As mentioned above, a user may specify that a specific data item can only be accessed for a particular use/purpose (e.g. private and/or public research) or by a particular type of organisation (e.g. Universities, research organisations, non-profit organisations, commercial companies, etc.) Thus, the third party may have to specify a reason why they want to access the user data items, so that only those user data items that are permitted to be shared for that reason are used to provide a response to the query.

The third party may wish to find data that relates to their research endeavors. For example, a skin cream manufacturer may be looking for phenotype data in people who have a specific gene related to a possible skin type. In another example, a study correlating specific genes to an increased incidence of a certain disease may need human genome data from anyone who has that disease.

Such queries are performed within platform 108. Thus, the method may comprise identifying, in storage 114, a plurality of user data items matching the search query (step S302). At step S304, the method may comprise determining, using permission settings associated with each user data item and the received reason, a first subset of user data items that can be shared with the third party.

A first response to the query may simply be a number equal to the number of user data items in the first subset (i.e. which match the received search query and have permissions settings corresponding to the received reason). This may help the third party to determine if they want to proceed further and request full access to the user data items. For example, if only a small number of user data items are identified, then the third party may not wish to obtain full access to the user data items, as the number may be too small to analyse and reach meaningful conclusions. Thus, at step S306 the method may comprise providing, to the third party, a response to the search query comprising a size of the first subset of user data items that match the received search query. In some cases, the response may comprise the size of the first subset of user data items, and some samples or example user data items that match the search query. User data items in the first subset may be added to a dataset, and access to the dataset that could be purchased by the third party through the data access platform 108.

The third party may be able to use user data items according to terms set by the owner of system 100. For example, the third party may be able to access data only for the duration that the third party needs access. That is, when the third party's research has ended, they will no longer be able to access the user data items. The third party may also be prevented from disclosing the user data items to any other party for any reason.

The method may comprise: receiving, from the third party, a request to access the first subset of user data items; and providing the third party with an access token to enable the third party to access the first subset of user data items through a secure portal 124. In some cases, the access token may enable the third party to view the first subset of user data items via the secure portal, but not to be able to download or copy the user data items. In this way, the user data items that are shared with a third party do not leave the storage and copies are not provided to the third party. Thus, the user retains at least some control of their user data at all times.

Third parties may be able to manage access control tokens for datasets that they have purchased via the data access platform 108. Access tokens may be added and removed. The tokens may enable the third parties to access specific data only, in a secure manner via secure portal 124.

It may be desirable to provide a user associated with each user data item accessed by a third party with feedback so that they know that a third party has accessed their data. For example, users may be provided with feedback on where or how their data is currently being used, such as the study their data is part of and the status of the study (e.g. completed or in progress). This provides users with information on how their data may be benefiting others. The method may comprise: identifying a user associated with each user data item of the first subset of user data items; and transmitting, to each identified user, a message indicating that a third party is accessing their user data item for the received reason.

Researchers/third parties may require follow-up information from users as part of their research. The system may enable users to be contacted. For example, researchers may submit their requests for additional information from the users whose user data items they have already accessed. The requests may be submitted via the third party interface 112b. The requests may be presented to each user, e.g. via the user interface 112a. The user may be able to submit a response or ignore the request via the user interface 112a. Thus, the data access platform 108 enables researchers to obtain further information from users while maintaining user privacy and ensuring the user has at least some control over what further information is shared.

In some cases, to encourage users to share more of their data, the method may comprise providing a reward, to each identified user associated with the first subset of user data items. For example, a user may be provided with a reward when they complete a survey submitted by a third party, or when access to their user data item(s) has been purchased by a third party. Monetary rewards may be provided to the users using cryptocurrency. This avoids the need for the system 100 to store bank details for the users. Such rewards may be made to the users immediately when a third party has paid for user data, so the owner of system 100 does not hold funds on behalf of the users.

The method may further comprise: determining a second subset of user data items that cannot be shared with the third party; identifying a user associated with each user data item of the second subset; and transmitting, to each identified user, a message indicating that a third party wants access to the user data item of the second subset associated with the user. Thus, the method enables users who have not already specified that the third party requesting the data can access their data with the opportunity to change the permission settings. This may be useful if, for example, a user has not provided any specific permission settings or has simply used default permission settings for their user data. By default, each user data item may be non-searchable and not shareable with any third party, to ensure the data remains private until the user specifies otherwise. However, if a user has not had time to change the permission settings, this method may prompt the user to do so in response to a third party request for particular data.

The size of the second subset of user data items, or any other information about the second subset may not be shared with the third party. However, if a user associated with a user data item in the second subset changes their permission settings to allow the third party to access the data item, the third party may be sent a message stating that another user data item has become available, and provide them with the option to obtain full access to the newly available user data item.

The method may further comprise: receiving, from the third party, a purchase request in relation to the first and/or second subset of user data items in the response.

The response to the search query may comprise a cost to access the subset of user data items. In this case, the method may further comprise: receiving, from the third party, a payment corresponding to the cost to access the subset of user data items; and providing the third party with an access token to enable the third party to access the first subset of user data items through secure portal 124.

The system 100 may further comprise a service market platform (not shown in FIG. 1). The service market platform may be provided within the data access platform 108, or may be communicatively coupled to platform 108. The service market platform may enable users to upload user data items, such as genotype data, and buy services that analyse the data. Example services include ancestry information, health analysis and cancer screening. Service providers may offer services through the platform 108 or the service market platform. The service providers may access the platform(s) via a web portal or interface.

Those skilled in the art will appreciate that while the foregoing has described what is considered to be the best mode and where appropriate other modes of performing present techniques, the present techniques should not be limited to the specific configurations and methods disclosed in this description of the preferred embodiment. Those skilled in the art will recognise that present techniques have a broad range of applications, and that the embodiments may take a wide range of modifications without departing from any inventive concept as defined in the appended claims.

1. A method for securely sharing user data items with third parties, the method comprising:
receiving at a user interface of a data access platform, from a user, a request to share a user data item, the request comprising:
information identifying a user data item to be shared,
information identifying a user profile for sharing the user data item, and
information specifying a permission setting for the user data item to be shared;
storing, in storage of the data access platform, an association between the permission setting, the identified user profile and the user data item;
determining, at the data access platform, whether the identified user data item is available in the storage and available to the user for sharing; and
adding, when the identified user data item is available in the storage, the user data item to a searchable database or a non-searchable database of the data access platform based on the permission setting.

2. The method as claimed in claim 1, wherein the information identifying the user profile for sharing the user data item is one of: a distributed identity (DID) document, or a pointer to a distributed identity (DID) document.

3. (canceled)

4. The method as claimed in claim 1, further comprising:
associating, when the identified user data item is available in the storage and is available to the user for sharing, the identified user data item with the stored permission setting.

5. The method as claimed in claim 4, wherein the identified user data item is provided in the storage by a third party.

6. The method as claimed in claim 1, further comprising:
providing, when the identified user data item is available in the storage but is not available to the user for sharing, the user with an option to obtain the identified user data item; and
associating, when the user obtains the identified user data item, the identified user data item with the stored permission setting.

7. The method as claimed in claim 2, further comprising:
requesting, when the identified user data item is not available in the storage, the identified user data item from the user.

8. The method as claimed in claim 1, wherein the information specifying the permission setting for the user data item comprises any one or more of: information restricting access to the user data item to a specific third party, information specifying the user data item can be used by a predefined set of third parties, information specifying that the user data item can be used for private research, information specifying that the user data item can be used for public research, and information specifying that the user data item can be used for private and public research.

9. The method as claimed in claim 1, wherein the user data item to be shared comprises any one of: genome data, health data, lifestyle data, location data, personal data, and biometric data.

10. (canceled)

11. The method as claimed in claim 1, further comprising:
receiving, from the user, a request to revoke access by third parties to a previously shared user data item.

12. The method as claimed in claim 11, further comprising:
removing, responsive to the request, the previously shared user data item from a database of searchable data.

13. The method as claimed in claim 11, further comprising:
deleting, responsive to the request, the previously shared user data item from the storage.

14. A method for securely sharing user data items with third parties, the method comprising:
receiving at a user interface of a data access platform, from a third party, a search query relating to a particular type of user data and a reason for wanting the user data;
identifying, in a searchable database of the data access platform, a plurality of user data items matching the search query;
determining, at the data access platform, using permission settings associated with each user data item and the received reason, a first subset of user data items that can be shared with the third party;
providing via the user interface, to the third party, a response to the search query comprising a size of the first subset of user data items that match the received search query;
receiving at the user interface, from the third party, a request to access the first subset of user data items; and
providing the third party with an access token to enable the third party to access the first subset of user data items through a secure portal of the data access platform.

15. (canceled)

16. The method as claimed in claim 14, further comprising:
identifying a user associated with each user data item of the first subset of user data items; and
transmitting, to each identified user, a message indicating that a third party is accessing their user data item for the received reason.

17. The method as claimed in claim 16, further comprising:
providing a reward to each identified user associated with the first subset of user data items.

18. The method as claimed in claim 14, further comprising:
determining a second subset of user data items that cannot be shared with the third party;
identifying a user associated with each user data item of the second subset; and
transmitting, to each identified user, a message indicating that a third party wants access to the user data item of the second subset associated with the user.

19. The method as claimed in claim 14, further comprising:
receiving, from the third party, a purchase request in relation to the subset of user data items in the response.

20. The method as claimed in 14, wherein the response to the search query comprises a cost to access the subset of user data items, and wherein the method further comprises:
receiving, from the third party, a payment corresponding to the cost to access the subset of user data items; and
providing the third party with an access token to enable the third party to access the first subset of user data items through a secure portal.

21. (canceled)

22. A system for securely sharing user data items with third parties, the system comprising:
a data access platform comprising:
storage for storing a plurality of user data items and at least one permission setting associated with each user data item;
a user interface for receiving, from a user, a request to share a user data item;
a third party user interface for receiving, from a third party, a search query relating to a particular type of user data and a reason for wanting the user data; and
a processor for carrying out the method of claim 1.

23. The system as claimed in claim 22, further comprising:
an identity authentication platform comprising:
storage storing a plurality of distributed identities (DIDs), wherein at least one DID is associated with each user of the system.
